(19) United States
(12) Patent Application Publication
(10) Pub. No.: US 2025/0116027 A1
(43) Pub. Date: Apr. 10, 2025

(54) PLATING APPARATUS AND PLATING METHOD

(71) Applicant: EBARA CORPORATION, Tokyo (JP)

(72) Inventor: Yasuyuki MASUDA, Tokyo (JP)

(21) Appl. No.: 18/293,706

(22) PCT Filed: Apr. 27, 2023
(86) PCT No.: PCT/JP2023/016570

§ 371 Date: Jan. 30, 2024

(51) Int. Cl. C25D 21/10; B01F 31/44; B01F 31/441

(52) U.S. Cl. CPC C25D 21/10; B01F 31/441; B01F 31/449

(57) ABSTRACT

Provided is a technique capable of improving the stirring force of a plating solution by a paddle. A plating apparatus 1000 includes a paddle 70 disposed between an anode 11 and a substrate Wf. The paddle is configured to reciprocate parallel to the anode in a first direction and a second direction to stir a plating solution Ps. The paddle includes a honeycomb-structure portion 71 provided with a plurality of polygonal through-holes 74. The honeycomb-structure portion has a shape in which a paddle width at a center portion in a third direction which is a direction perpendicular to a reciprocation direction of the paddle is wider than a paddle width at an end portion in the third direction. The honeycomb-structure portion includes a first outer peripheral wall 75 oriented in the first direction. The first outer peripheral wall includes a first center wall 77 disposed at a center portion in the third direction of the first outer peripheral wall, and the first center wall extends in the third direction.

### TECHNICAL FIELD

The present invention relates to a plating apparatus and a plating method.

### BACKGROUND ART

Conventionally, there has been known a plating apparatus that can perform a plating process on a substrate (for example, see PTL 1). Such plating apparatus includes a plating tank that stores a plating solution and includes an anode therein, a substrate holder that holds a substrate as a cathode so as to be opposed to the anode, and a paddle disposed between the anode and the substrate. The paddle is configured to reciprocate parallel to the anode in a first direction and a second direction opposite to the first direction to stir the plating solution, and includes a honeycomb-structure portion provided with a plurality of polygonal through-holes. The plating apparatus includes the paddle with the honeycomb-structure portion, thus intending to improve the stirring force of the plating solution by the paddle.

The honeycomb-structure portion of the paddle disclosed in PTL 1 has a shape in which a paddle width (paddle length in a reciprocation direction) at a center portion in a third direction which is a direction perpendicular to the reciprocation direction of the paddle is wider than a paddle width at an end portion in the third direction. Additionally, an outer peripheral wall of the honeycomb-structure portion has an arc shape at the center portion in the third direction.

### CITATION LIST

### Patent Literature

PTL 1: Japanese Patent No. 7079388

### SUMMARY OF INVENTION

### Technical Problem

Since the conventional paddle as described above has the outer peripheral wall of the honeycomb-structure portion formed into the arc shape at the center portion in the third direction, for example, when the paddle reciprocates, the plating solution easily escapes along the arc-shaped center portion of the outer peripheral wall. Therefore, the conventional technique has room for improvement in the aspect of intending to improve the stirring force of the plating solution by the paddle.

The present invention has been made in view of the above, and it is one of the objects to provide a technique capable of improving the stirring force of a plating solution by a paddle.

### Solution to Problem

### (Aspect 1)

To achieve the above-described object, a plating apparatus according to one aspect of the present invention includes a plating tank, a substrate holder, and a paddle. The plating tank is configured to store a plating solution, and an anode is disposed in the plating tank. The substrate holder is configured to hold a substrate as a cathode so as to be opposed to the anode. The paddle is disposed between the anode and the substrate. The paddle is configured to reciprocate parallel to the anode in a first direction and a second direction opposite to the first direction to stir the plating solution. The paddle includes a honeycomb-structure portion provided with a plurality of polygonal through-holes. The honeycomb-structure portion has a shape in which a paddle width at a center portion in a third direction is wider than a paddle width at an end portion in the third direction, and the third direction is a direction perpendicular to a reciprocation direction of the paddle. The honeycomb-structure portion includes a first outer peripheral wall oriented in the first direction. The first outer peripheral wall includes a first center wall disposed at a center portion in the third direction of the first outer peripheral wall, and the first center wall extends in the third direction.

According to this aspect, since the first outer peripheral wall of the honeycomb-structure portion of the paddle includes the first center wall extending in the third direction (that is, a direction perpendicular to the reciprocation direction of the paddle), the first center wall can effectively push out the plating solution in the first direction when the paddle moves in the first direction. This allows improving the stirring force of the plating solution by the paddle.

### (Aspect 2)

In the above-described aspect 1, the honeycomb-structure portion may include a second outer peripheral wall oriented in the second direction, the second outer peripheral wall may include a second center wall disposed at a center portion in the third direction of the second outer peripheral wall, and the second center wall extends in the third direction.

According to this aspect, since the second outer peripheral wall of the honeycomb-structure portion of the paddle includes the second center wall extending in the third direction, the second center wall can effectively push out the plating solution in the second direction when the paddle moves in the second direction. This allows further improving the stirring force of the plating solution by the paddle.

### (Aspect 3)

In the above-described aspect 1 or 2, the first outer peripheral wall may include a pair of first inclined walls extending from both end portions of the first center wall as starting points in the second direction and directions approaching end portions of the honeycomb-structure portion.

### (Aspect 4)

In the above-described aspect 3, at least one of the pair of first inclined walls may be provided with at least one step.

This configuration allows further improving the stirring force of the plating solution.

### (Aspect 5)

In any one aspect of the above-described aspects 2 to 4, the second outer peripheral wall may include a pair of second inclined walls extending from a center portion side in the third direction of the second outer peripheral wall toward the first direction while approaching end portion sides.

### (Aspect 6)

In the above-described aspect 5, the second outer peripheral wall may include a pair of connection walls configured to connect both end portions of the second center wall to the pair of second inclined walls respectively.

### (Aspect 7)

To achieve the above-described object, a plating method according to one aspect of the present invention is a plating method using the plating apparatus according to any one aspect of the above-described aspects 1 to 6. The method includes: immersing the substrate in the plating solution; reciprocating the paddle in the first direction and the second direction to stir the plating solution; and performing a plating process on the substrate.

This aspect allows improving the stirring force of the plating solution by the paddle.

### BRIEF DESCRIPTION OF DRAWINGS

FIG. 1 is a perspective view illustrating an overall configuration of a plating apparatus according to an embodiment.

FIG. 2 is a plan view illustrating the overall configuration of the plating apparatus according to the embodiment.

FIG. 3 is a schematic diagram illustrating a configuration of a plating module of the plating apparatus according to the embodiment.

FIG. 4 is a schematic diagram illustrating a state where a substrate is immersed in a plating solution according to the embodiment.

FIG. 5 is a schematic diagram for describing a paddle and a driving device according to the embodiment.

FIG. 6 is a schematic plan view of the paddle according to the embodiment.

FIG. 7 is a flowchart for describing a sequence of operations from the supply of the plating solution to the start of a plating process according to the embodiment.

FIG. 8 is a schematic plan view of a paddle of a plating apparatus according to a comparative example.

FIG. 9 is a schematic plan view illustrating a peripheral configuration of a first outer peripheral wall of a paddle according to Modification 1 of the embodiment.

FIG. 10 is an example of a simulation result for proving an effect of the paddle according to Modification 1 of the embodiment.

FIG. 11 is a schematic plan view illustrating a peripheral configuration of a second outer peripheral wall of the paddle according to Modification 1 of the embodiment.

FIG. 12 is a schematic plan view illustrating a peripheral configuration of a second outer peripheral wall of a paddle according to Modification 2 of the embodiment.

FIG. 13 is a schematic plan view illustrating a peripheral configuration of a first outer peripheral wall of a paddle according to Modification 3 of the embodiment.

### DESCRIPTION OF EMBODIMENTS

The following describes embodiments of the present invention with reference to the drawings. Note that the drawings give schematic illustrations to facilitate understanding of features of constituent elements, and the dimensional proportion and the like of each constituent element are not necessarily the same as those of the actual one. In some drawings, orthogonal coordinates of X-Y-Z are illustrated for reference. Of the orthogonal coordinates, the Z-direction corresponds to an upper side, and the −Z-direction corresponds to a lower side (direction in which gravity acts).

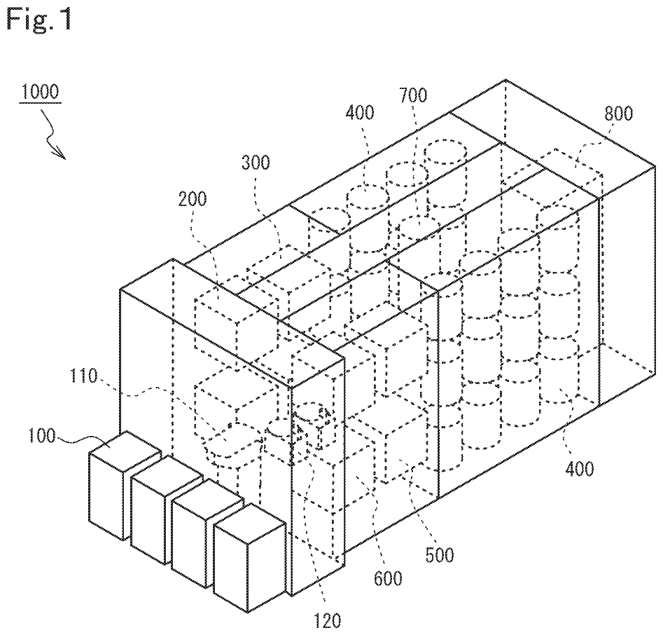

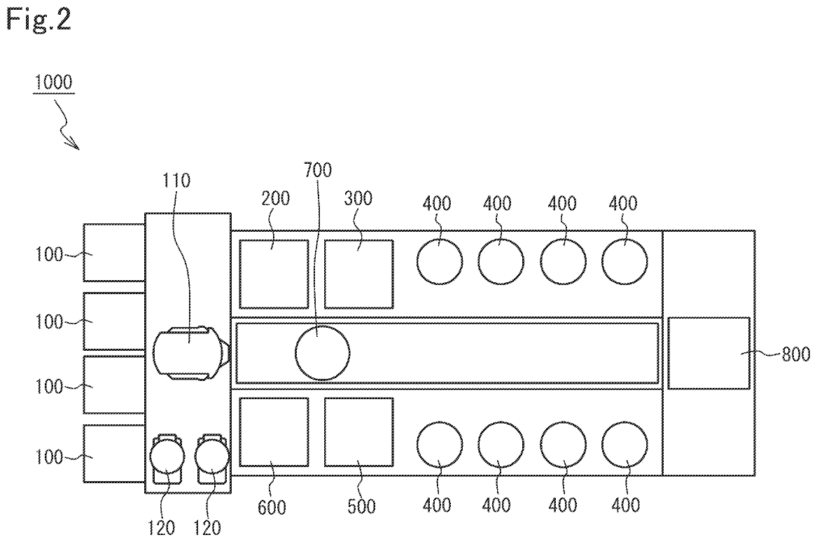

FIG. 1 is a perspective view illustrating an overall configuration of a plating apparatus 1000 of this embodiment. FIG. 2 is a plan view (top view) illustrating the overall configuration of the plating apparatus 1000 of this embodiment. As illustrated in FIG. 1 and FIG. 2, the plating apparatus 1000 includes load ports 100, a transfer robot 110, aligners 120, pre-wet modules 200, pre-soak modules 300, plating modules 400, cleaning modules 500, spin rinse dryers 600, a transfer device 700, and a control module 800.

The load port 100 is a module for loading a substrate housed in a cassette, such as a FOUP, (not illustrated) to the plating apparatus 1000 and unloading the substrate from the plating apparatus 1000 to the cassette. While the four load ports 100 are disposed to be arranged in the horizontal direction in this embodiment, the number of load ports 100 and the arrangement of the load ports 100 are arbitrary. The transfer robot 110 is a robot for transferring the substrate that is configured to grip or release the substrate between the load port 100, the aligner 120, the pre-wet module 200, and the spin rinse dryer 600. The transfer robot 110 and the transfer device 700 can perform the grip or release of the substrate via a temporary placement table (not illustrated) to grip or release the substrate between the transfer robot 110 and the transfer device 700.

The aligner 120 is a module for adjusting a position of an orientation flat, a notch, and the like of the substrate in a predetermined direction. While the two aligners 120 are disposed to be arranged in the horizontal direction in this embodiment, the number of aligners 120 and the arrangement of the aligners 120 are arbitrary. The pre-wet module 200 wets a surface to be plated of the substrate before a plating process with a process liquid, such as pure water or deaerated water, to replace air inside a pattern formed on the surface of the substrate with the process liquid. The pre-wet module 200 is configured to perform a pre-wet process to facilitate supplying the plating solution to the inside of the pattern by replacing the process liquid inside the pattern with a plating solution during plating. While the two pre-wet modules 200 are disposed to be arranged in the vertical direction in this embodiment, the number of pre-wet modules 200 and the arrangement of the pre-wet modules 200 are arbitrary.

For example, the pre-soak module 300 is configured to remove an oxidized film having a large electrical resistance present on a surface of a seed layer formed on the surface to be plated of the substrate before the plating process by etching with a process liquid, such as sulfuric acid and hydrochloric acid, and perform a pre-soak process that cleans or activates a surface of a plating base layer. While the two pre-soak modules 300 are disposed to be arranged in the vertical direction in this embodiment, the number of pre-soak modules 300 and the arrangement of the pre-soak modules 300 are arbitrary. The plating module 400 performs the plating process on the substrate. There are two sets of the 12 plating modules 400 disposed to be arranged by three in the vertical direction and by four in the horizontal direction, and the total 24 plating modules 400 are disposed in this embodiment, but the number of plating modules 400 and the arrangement of the plating modules 400 are arbitrary.

The cleaning module 500 is configured to perform a cleaning process on the substrate to remove the plating solution or the like left on the substrate after the plating process. While the two cleaning modules 500 are disposed to be arranged in the vertical direction in this embodiment, the number of cleaning modules 500 and the arrangement of the cleaning modules 500 are arbitrary. The spin rinse dryer 600 is a module for rotating the substrate after the cleaning process at high speed and drying the substrate. While the two spin rinse dryers 600 are disposed to be arranged in the vertical direction in this embodiment, the number of spin rinse dryers 600 and the arrangement of the spin rinse dryers 600 are arbitrary. The transfer device 700 is a device for transferring the substrate between the plurality of modules inside the plating apparatus 1000. The control module 800 is configured to control the plurality of modules in the plating apparatus 1000 and can be configured of, for example, a general computer including input/output interfaces with an operator or a dedicated computer.

An example of a sequence of the plating processes by the plating apparatus 1000 will be described. First, the substrate housed in the cassette is loaded on the load port 100. Subsequently, the transfer robot 110 grips the substrate from the cassette at the load port 100 and transfers the substrate to the aligners 120. The aligner 120 adjusts the position of the orientation flat, the notch, or the like of the substrate in the predetermined direction. The transfer robot 110 grips or releases the substrate whose direction is adjusted with the aligners 120 to the pre-wet module 200.

The pre-wet module 200 performs the pre-wet process on the substrate. The transfer device 700 transfers the substrate on which the pre-wet process has been performed to the pre-soak module 300. The pre-soak module 300 performs the pre-soak process on the substrate. The transfer device 700 transfers the substrate on which the pre-soak process has been performed to the plating module 400. The plating module 400 performs the plating process on the substrate.

The transfer device 700 transfers the substrate on which the plating process has been performed to the cleaning module 500. The cleaning module 500 performs the cleaning process on the substrate. The transfer device 700 transfers the substrate on which the cleaning process has been performed to the spin rinse dryer 600. The spin rinse dryer 600 performs the drying process on the substrate. The transfer robot 110 receives the substrate from the spin rinse dryer 600, and transfers the substrate on which the drying process has been performed to the cassette at the load port 100. Finally, the cassette housing the substrate is unloaded from the load port 100.

The configuration of the plating apparatus 1000 described in FIG. 1 and FIG. 2 is merely an example, and the configuration of the plating apparatus 1000 is not limited to the configuration in FIG. 1 or FIG. 2.

Subsequently, the plating modules 400 will be described. Since the plurality of plating modules 400 included in the plating apparatus 1000 according to this embodiment have the similar configurations, one of the plating modules 400 will be described.

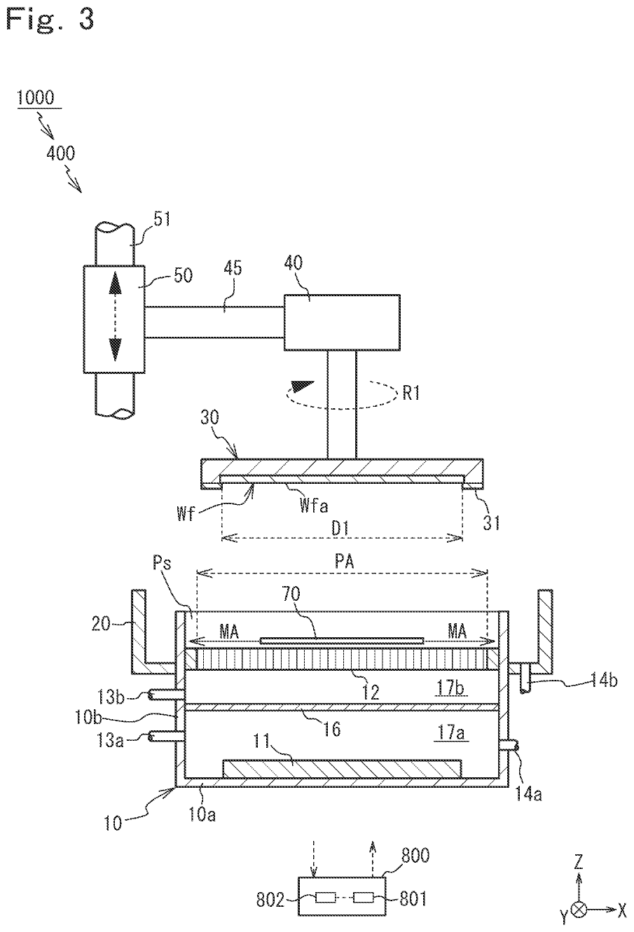

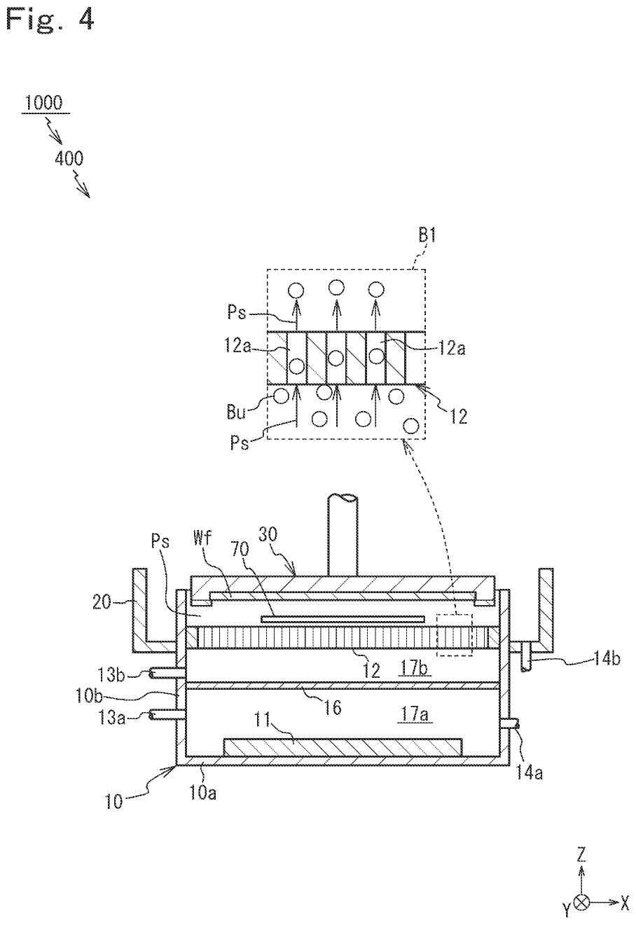

FIG. 3 is a schematic diagram illustrating the configuration of the plating module 400 of the plating apparatus 1000 according to this embodiment. Specifically, FIG. 3 schematically illustrates the plating module 400 in a state before a substrate Wf is immersed in a plating solution Ps. FIG. 4 is a schematic diagram illustrating a state where the substrate Wf is immersed in the plating solution Ps.

The plating apparatus 1000 illustrated in FIG. 3 and FIG. 4 is, for example, a cup type plating apparatus. However, the configuration is not limited thereto, and the plating apparatus 1000 according to this embodiment may be, for example, a plating apparatus of a type in which the substrate Wf having a surface direction in the vertical direction is immersed in the plating solution Ps (that is, a vertical-type plating apparatus).

The plating module 400 of the plating apparatus 1000 illustrated in FIG. 3 and FIG. 4 includes a plating tank 10, an overflow tank 20, a substrate holder 30, and a paddle 70. The plating module 400 may include a rotation mechanism 40, an inclination mechanism 45, and an elevating mechanism 50, as illustrated in FIG. 3.

The plating tank 10 according to this embodiment is configured by a container having an opening in its upper side and a bottom. Specifically, the plating tank 10 has a bottom wall 10a and an outer peripheral wall 10b that extends upward from an outer peripheral edge of this bottom wall 10a, and an upper portion of this outer peripheral wall 10b is opened. Although the shape of the outer peripheral wall 10b of the plating tank 10 is not particularly limited, the outer peripheral wall 10b according to this embodiment has a cylindrical shape as an example. The plating tank 10 internally stores the plating solution Ps.

It is only necessary that the plating solution Ps is a solution that contains metallic element ions constituting a plating film, and the specific examples are not particularly limited. In this embodiment, a copper plating process is used as an example of the plating process, and a copper sulfate solution is used as an example of the plating solution Ps. Furthermore, the plating solution Ps may contain a predetermined additive.

The plating tank 10 internally includes an anode 11. A specific type of the anode 11 is not particularly limited, and an insoluble anode or a soluble anode may be used. In this embodiment, an insoluble anode is used as an example of the anode 11. A specific type of this insoluble anode is not particularly limited, and platinum, iridium oxide, and the like can be used.

As illustrated in FIG. 3 and FIG. 4, inside the plating tank 10, an ionically resistive element 12 may be disposed above the anode 11. Specifically, as illustrated in FIG. 4 (enlarged view of part B1), the ionically resistive element 12 is configured of a porous plate member having a plurality of holes 12a (pores). The holes 12a are provided such that a lower surface and an upper surface of the ionically resistive element 12 communicate with each other.

As illustrated in FIG. 3, a region in which the plurality of holes 12a are formed in the ionically resistive element 12 is referred to as a “hole-formed area PA.” The hole-formed area PA according to this embodiment has a circular shape in plan view. The hole-formed area PA according to this embodiment has an area that is the same as an area of a surface to be plated Wfa of the substrate Wf or greater than the area of the surface to be plated Wfa. However, the hole-formed area PA is not limited to this configuration, and may have an area that is smaller than the area of the surface to be plated Wfa of the substrate Wf.

The ionically resistive element 12 is disposed to attempt homogenization of an electric field formed between the anode 11 and the substrate Wf as a cathode. As in this embodiment, by the ionically resistive element 12 being disposed in the plating tank 10, the uniformization of the film thickness of the plating film (plated layer) formed on the substrate Wf can be easily attempted.

As illustrated in FIG. 3 and FIG. 4, inside the plating tank 10, a membrane 16 may be disposed at a position above the anode 11 and below the ionically resistive element 12. In this case, the inside of the plating tank 10 is partitioned by the membrane 16 into an anode chamber 17a below the membrane 16 and a cathode chamber 17b above the membrane 16. The anode 11 is disposed in the anode chamber 17a, and the ionically resistive element 12 and the substrate Wf are disposed in the cathode chamber 17b. The membrane 16 is configured to allow ion species including metal ions included in the plating solution Ps to pass through the membrane 16 while inhibiting nonionic plating additives included in the plating solution Ps from passing through the membrane 16. As the membrane 16, for example, an ion exchange membrane can be used.

The plating tank 10 is provided with a supply port for supplying the plating solution Ps to the plating tank 10. Specifically, the outer peripheral wall 10b of the plating tank 10 according to this embodiment is provided with a first supply port 13a for supplying the plating solution Ps to the anode chamber 17a and a second supply port 13b for supplying the plating solution Ps to the cathode chamber 17b.

The plating tank 10 is provided with a first discharge port 14a for discharging the plating solution Ps in the anode chamber 17a to the outside of the plating tank 10. The plating solution Ps discharged from the first discharge port 14a is pressure-fed by a pump (not illustrated), and supplied to the anode chamber 17a from the first supply port 13a again.

The overflow tank 20 is configured by a container with a bottom, disposed outside the plating tank 10. The overflow tank 20 is disposed for temporarily storing the plating solution Ps that flows over an upper end of the outer peripheral wall 10b of the plating tank 10 (that is, the plating solution Ps that has overflowed from the plating tank 10). The plating solution Ps stored in the overflow tank 20 is pressure-fed by a pump (not illustrated) after discharged from a second discharge port 14b and supplied to the cathode chamber 17b from the second supply port 13b again.

The substrate holder 30 holds the substrate Wf as a cathode such that the surface to be plated Wfa of the substrate Wf is opposed to the anode 11. In this embodiment, specifically, the surface to be plated Wfa of the substrate Wf is disposed on a surface oriented to a lower side (lower surface) of the substrate Wf.

As illustrated in FIG. 3, the substrate holder 30 may include a ring 31 disposed so as to project below an outer peripheral edge of the surface to be plated Wfa of the substrate Wf. Specifically, the ring 31 according to this embodiment has a ring shape in bottom view.

The substrate holder 30 is connected to the rotation mechanism 40. The rotation mechanism 40 is a mechanism for rotating the substrate holder 30. “R1” illustrated in FIG. 3 is an exemplary rotation direction of the substrate holder 30. As the rotation mechanism 40, a publicly known rotation motor and the like can be used. The inclination mechanism 45 is a mechanism for inclining the rotation mechanism 40 and the substrate holder 30. The elevating mechanism 50 is supported by a spindle 51 extending in the vertical direction. The elevating mechanism 50 is a mechanism for moving up and down the substrate holder 30, the rotation mechanism 40, and the inclination mechanism 45 in the vertical direction. As the elevating mechanism 50, a publicly known elevating mechanism, such as a linear motion type actuator, can be used.

The control module 800 includes a microcomputer which includes a processor 801, a storage device 802 as a non-transitory storage medium, and the like. By the processor 801 operating based on commands of a program stored in the storage device 802, the control module 800 controls the operation of the plating module 400.

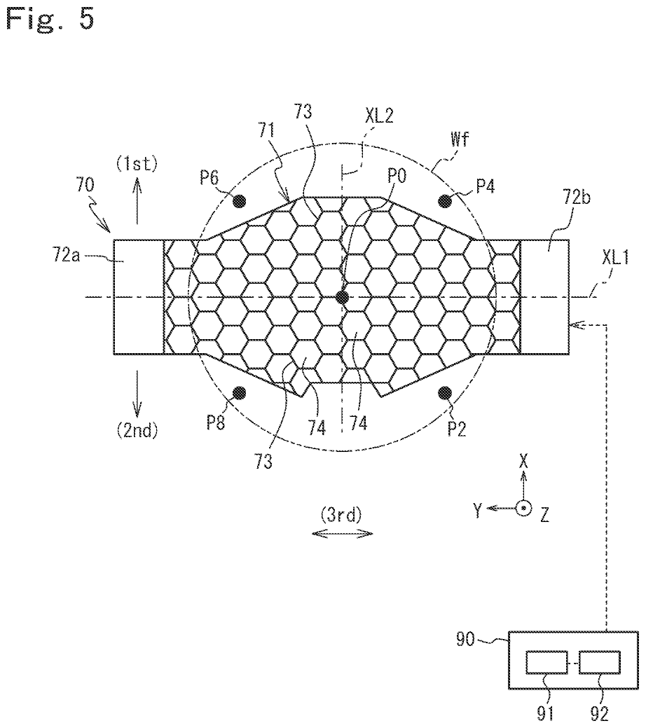

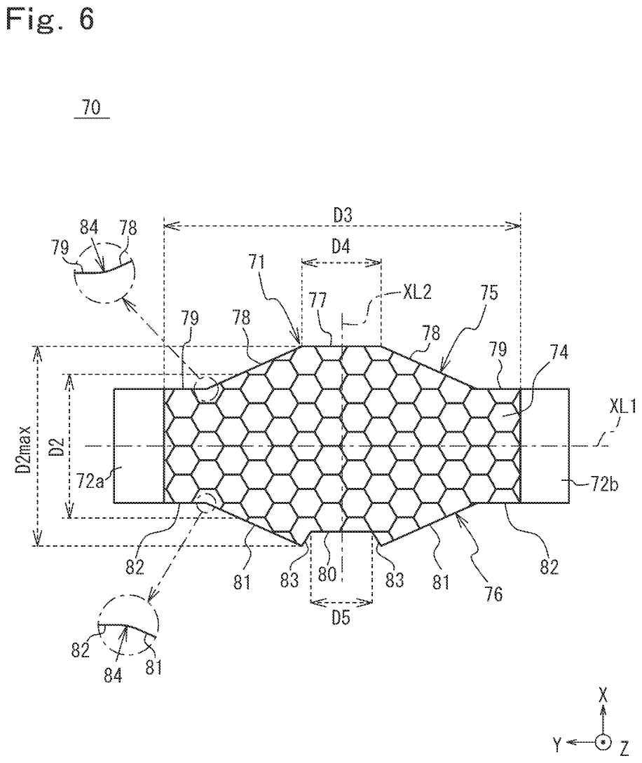

FIG. 5 is a schematic diagram for describing the paddle 70 and a driving device 90 described later. FIG. 6 is a schematic plan view of the paddle 70. With reference to FIG. 3 to FIG. 6, the paddle 70 is located at a position between the anode 11 and the substrate Wf inside the plating tank 10. Specifically, the paddle 70 according to this embodiment is located between the ionically resistive element 12 disposed above the anode 11 and the substrate Wf.

With reference to FIG. 5, the paddle 70 is driven by the driving device 90. The operation of the driving device 90 is controlled by the control module 800. By driving the paddle 70, the plating solution Ps in the plating tank 10 is stirred.

On receiving instructions from the control module 800, the driving device 90 according to this embodiment drives the paddle 70 alternately in a “first direction (in this embodiment, for example, the X-direction)” and a “second direction (in this embodiment, for example, the −X-direction)” opposite to the first direction, which are directions parallel to the anode 11 (or the substrate Wf). That is, the paddle 70 according to this embodiment reciprocates in the first direction and the second direction.

The mechanical mechanism itself of the driving device 90 is similar to publicly known driving devices, for example, disclosed in PTL 1 and Japanese Unexamined Patent Application Publication No. 2021-130848. That is, the driving device 90 according to this embodiment includes an electric motor 91, and a power conversion mechanism 92 that is connected to the paddle 70 and configured to convert a rotational motion of the electric motor 91 to a linear reciprocating motion to transmit it to the paddle 70.

The first direction or the second direction is not limited to the above-described direction. As another example, the first direction may be the −X-direction, and the second direction may be the X-direction. A direction perpendicular to the reciprocation direction of the paddle 70 is referred to as a “third direction (in this embodiment, for example, the Y-direction and the −Y-direction).” FIG. 5 and FIG. 6 illustrate a first central axis line XL1 extending in the third direction and a second central axis line XL2 extending in the reciprocation direction of the paddle 70 as central axis lines of the paddle 70.

The paddle 70 is preferred to be configured such that a moving region MA of the paddle 70 when stirring the plating solution Ps (that is, a range in which the paddle 70 reciprocates) covers the entire hole-formed area PA of the ionically resistive element 12 in plan view. With this configuration, the plating solution Ps above the hole-formed area PA of the ionically resistive element 12 can be effectively stirred by the paddle 70.

Note that it is only necessary that the paddle 70 is disposed inside the plating tank 10 at least when stirring the plating solution Ps, and it need not be always disposed inside the plating tank 10. For example, in a case where the driving of the paddle 70 is stopped and the stirring of the plating solution Ps by the paddle 70 is not performed, a configuration in which the paddle 70 is disposed outside the plating tank 10 is allowed.

The paddle 70 includes a honeycomb-structure portion 71 having a honeycomb structure, and a pair of outer frames (a first outer frame 72a and a second outer frame 72b) connected to end portions in the third direction of the honeycomb-structure portion 71. While the specific structures of the first outer frame 72a and the second outer frame 72b are not particularly limited, for example, the first outer frame 72a and the second outer frame 72b according to this embodiment are configured by flat plate-shaped members. At least one of the first outer frame 72a and the second outer frame 72b is connected to the driving device 90.

The honeycomb-structure portion 71 is provided with a plurality of polygonal through-holes 74 partitioned by beam members 73. The through-hole 74 according to this embodiment penetrates in the vertical direction such that an upper surface and a lower surface of the honeycomb-structure portion 71 communicate with each other.

The specific shape of the polygon of the through-hole 74 is not particularly limited, and various kinds of N-gons (N is a natural number of three or more) such as a triangle, a quadrangle, a pentagon, a hexagon, a heptagon, and an octagon can be used. In this embodiment, a hexagon is used as an example of the polygon.

With reference to FIG. 6, the honeycomb-structure portion 71 according to this embodiment has a portion in which a “paddle width D2 (length in the reciprocation direction of the paddle 70)” of the honeycomb-structure portion 71 changes along the third direction in plan view. Specifically, the honeycomb-structure portion 71 has a shape in which the paddle width D2 at a center portion in the third direction (distance between a first center wall 77 and a second center wall 80 described later) is wider than the paddle width D2 at the end portion in the third direction (distance between a first end wall 79 and a second end wall 82 described later). In other words, the honeycomb-structure portion 71 has a shape in which a portion in a center side with respect to the end portions in the third direction projects in the first direction and the second direction with respect to the end portions.

With this configuration, for example, compared with a case where the paddle width D2 at the center portion is the same as the paddle width D2 at the end portion in the honeycomb-structure portion 71, an area in which the paddle 70 can perform stirring when the paddle 70 moves by a certain distance can be expanded.

The honeycomb-structure portion 71 according to this embodiment has, for example, a line-symmetric (bilaterally symmetrical) shape with respect to the second central axis line XL2.

The honeycomb-structure portion 71 according to this embodiment includes a first outer peripheral wall 75 oriented in the first direction and a second outer peripheral wall 76 oriented in the second direction. The first outer peripheral wall 75 and the second outer peripheral wall 76 are configured by the beam members 73.

The first outer peripheral wall 75 includes the first center wall 77, a pair of first inclined walls 78, and a pair of first end walls 79.

The first center wall 77 is disposed at a center portion in the third direction of the first outer peripheral wall 75. The first center wall 77 extends in the third direction. In other words, the first center wall 77 extends parallel to the first central axis line XL1. That is, the first center wall 77 according to this embodiment is configured by not a curved surface projecting in an arc shape in the first direction, but a planar surface linearly extending in the third direction.

The pair of first inclined walls 78 extend from a center portion side in the third direction of the first center wall 77 toward the second direction while approaching end portion sides. Specifically, the pair of first inclined walls 78 according to this embodiment extend from both end portions of the first center wall 77 as starting points in the second direction and directions approaching the end portions of the honeycomb-structure portion 71. In other words, the pair of first inclined walls 78 extend from both end portions of the first center wall 77 as starting points in a direction away from the second central axis line XL2, and extend to approach the first central axis line XL1 as they get away from the second central axis line XL2.

The pair of first end walls 79 extend from respective end portions of the pair of first inclined walls 78 as starting points in the third direction. In other words, the pair of first end walls 79 extend from the respective end portions of the pair of first inclined walls 78 as starting points in the direction away from the second central axis line XL2, and extend parallel to the first central axis line XL1.

When the paddle 70 moves in the first direction, a large stress is applied to connecting portions of the pair of first inclined walls 78 and the pair of first end walls 79 from the plating solution Ps. In view of this, the connecting portions of the pair of first inclined walls 78 and the pair of first end walls 79 are preferably formed into curved surfaces 84 (in other words, R surfaces) having a predetermined curvature. With this configuration, the strengths of the connecting portions of the pair of first inclined walls 78 and the pair of first end walls 79 can be improved.

The second outer peripheral wall 76 includes the second center wall 80, a pair of second inclined walls 81, a pair of the second end walls 82, and a pair of connection walls 83.

The second center wall 80 is disposed at a center portion in the third direction of the second outer peripheral wall 76. The second center wall 80 extends in the third direction. In other words, the second center wall 80 extends parallel to the first central axis line XL1. That is, the second center wall 80 according to this embodiment is configured by not a curved surface projecting in an arc shape in the second direction, but a planar surface linearly extending in the third direction.

The pair of second inclined walls 81 extend from a center portion side in the third direction of the second outer peripheral wall 76 toward the first direction while approaching end portion sides. In other words, the pair of second inclined walls 81 extend in the direction away from the second central axis line XL2, and extend to approach the first central axis line XL1 as they get away from the second central axis line XL2.

The pair of connection walls 83 connect both end portions of the second center wall 80 to the pair of second inclined walls 81 respectively. The pair of connection walls 83 according to this embodiment extend from respective both end portions of the second center wall 80 as starting points in the second direction. Furthermore, the pair of connection walls 83 according to this embodiment extend to approach the end portions of the honeycomb-structure portion 71 as they extend toward the second direction.

However, the configuration of the connection wall 83 is not limited thereto. For example, the connection wall 83 may extend in the reciprocation direction of the paddle 70 (in other words, may extend parallel to the second central axis line XL2).

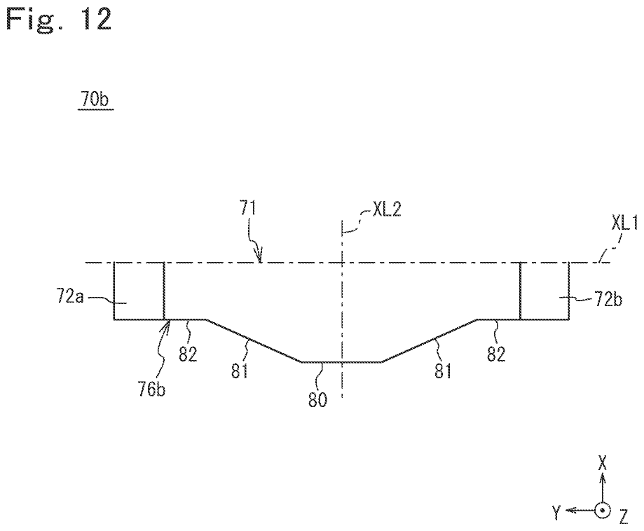

Since the second outer peripheral wall 76 of the paddle 70 according to this embodiment includes the above-described connection wall 83, a region defined by the second center wall 80 and the pair of connection walls 83 is formed into a “depressed portion” depressed in the first direction. However, this is merely an example of the second outer peripheral wall 76, and the configuration of the second outer peripheral wall 76 is not limited to the shape with the connection wall 83 (that is, the shape with the depressed portion). An example of the second outer peripheral wall 76 without the connection wall 83 will be described in FIG. 12 below.

The pair of second end walls 82 extend from respective end portions of the pair of second inclined walls 81 as starting points in the third direction. In other words, the pair of second end walls 82 extend from the respective end portions of the pair of second inclined walls 81 as starting points in the direction away from the second central axis line XL2, and extend parallel to the first central axis line XL1.

When the paddle 70 moves in the second direction, a large stress is applied to connecting portions of the pair of second inclined walls 81 and the pair of second end walls 82 from the plating solution Ps. In view of this, the connecting portions of the pair of second inclined walls 81 and the pair of second end walls 82 are preferably formed into the curved surfaces 84 (in other words, the R surfaces) having a predetermined curvature. With this configuration, the strengths of the connecting portions of the pair of second inclined walls 81 and the pair of second end walls 82 can be improved.

The first center wall 77 has a length (D4) in the third direction of, for example, 5% or more and 50% or less of the length in the third direction (that is, the whole length (D3)) of the honeycomb-structure portion 71. The second center wall 80 has a length (D5) in the third direction of, for example, 5% or more and 50% or less of the whole length (D3) of the honeycomb-structure portion 71. In the configuration illustrated in FIG. 6, for example, the first center wall 77 has the length (D4) longer than the length (D5) of the second center wall 80. However, these are merely examples of the lengths of the first center wall 77 and the second center wall 80, and the lengths of the first center wall 77 and the second center wall 80 are not limited to these examples.

A “maximum value (D2max)” of the paddle width D2 may be larger than or smaller than a “substrate width D1 (this reference numeral is illustrated in FIG. 3)” that is a maximum value of a distance between an outer edge in the first direction and an outer edge in the second direction of the surface to be plated Wfa of the substrate Wf. Alternatively, the maximum value (D2max) of the paddle width D2 may be the same value as the substrate width D1.

However, a larger clearance between the paddle 70 and the outer peripheral wall 10b of the plating tank 10 can be ensured in a case where the maximum value (D2max) of the paddle width D2 is smaller than the substrate width D1 compared with a case where the maximum value (D2max) of the paddle width D2 is the same as the substrate width D1 or larger than the substrate width D1. Consequently, a moving distance in the first direction and the second direction of the paddle 70 (that is, a stroke in the reciprocation of the paddle 70) inside the plating tank 10 can be increased. This allows the effective stirring of the plating solution Ps by the paddle 70. In this aspect, the maximum value (D2max) of the paddle width D2 is preferably smaller than the substrate width D1.

Note that, in a case where the surface to be plated Wfa of the substrate Wf has a circular shape, the substrate width D1 corresponds to the diameter of the surface to be plated Wfa. In a case where the surface to be plated Wfa of the substrate Wf has a quadrangular shape, the substrate width D1 corresponds to a maximum value of a clearance between a side in the first direction of the surface to be plated Wfa and an opposing side (side in the second direction).

While a specific method for fabricating the paddle 70 is not particularly limited, the paddle 70 according to this embodiment can be fabricated, for example, using a publicly known three-dimensional printer, such as a 3D printer.

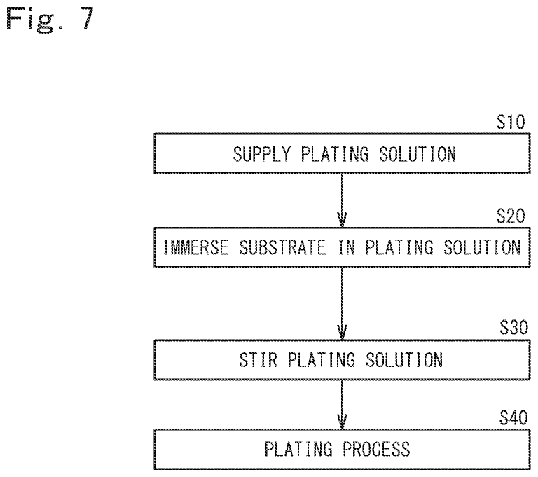

FIG. 7 is a flowchart for describing a sequence of operations from the supply of the plating solution to the start of the plating process according to this embodiment. First, the plating solution Ps is supplied to the plating tank 10 (Step S10). Specifically, the plating solution Ps is supplied to the plating tank 10 so as to immerse the anode 11 and the ionically resistive element 12 in the plating solution Ps. More specifically, in this embodiment, the plating solution Ps is supplied to the plating tank 10 from the first supply port 13a and the second supply port 13b.

Next, the substrate Wf is immersed in the plating solution Ps (Step S20). Specifically, in this embodiment, the elevating mechanism 50 moves down the substrate holder 30, thereby immersing at least the surface to be plated Wfa of the substrate Wf in the plating solution Ps.

Next, the driving device 90 starts the driving of the paddle 70, thereby starting the stirring of the plating solution Ps by the paddle 70 (Step S30).

Next, an energization device (not illustrated) flows electricity between the anode 11 and the substrate Wf, thereby starting the plating process on the substrate Wf (Step S40). Thus, the formation of the plating film on the surface to be plated Wfa of the substrate Wf is started.

Specifically, in this embodiment, also during the execution of the plating process on the substrate Wf according to Step S40, the stirring of the plating solution Ps by the paddle 70 according to Step S30 is performed (that is, while the plating solution Ps is stirred, the formation of the plating film on the surface to be plated Wfa is performed).

The timing of the stirring of the plating solution Ps by the paddle 70 is not limited to the above-described timing. For example, also at timing between Step S10 and Step S20 (that is, timing after supplying the plating solution Ps to the plating tank 10 and before immersing the substrate Wf in the plating solution Ps), the plating solution Ps may be stirred by the paddle 70.

Subsequently, operational advantages of the above-described plating apparatus 1000 will be described. First, since the plating apparatus 1000 according to this embodiment includes the paddle 70 with the honeycomb-structure portion 71, the arrangement density of the beam members 73 (that is, stirring members) can be increased compared with a case where the paddle 70 does not include the honeycomb-structure portion 71. This allows the effective stirring of the plating solution Ps. Additionally, the strength of the paddle 70 can be improved.

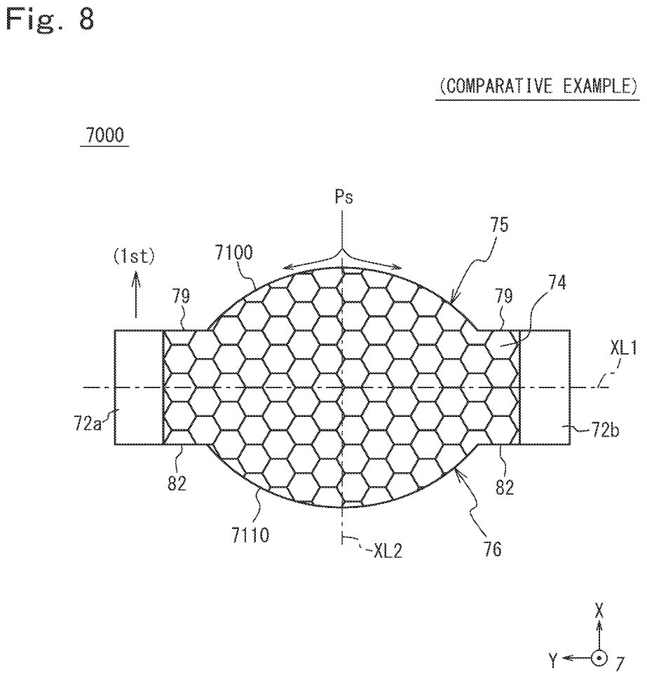

Furthermore, this embodiment can provide an operational advantage described below. This operational advantage will be described by comparison with a comparative example. FIG. 8 is a schematic plan view of a paddle 7000 of a plating apparatus according to the comparative example. Specifically, FIG. 8 schematically illustrates a state where the paddle 7000 according to the comparative example has moved in the first direction.

The paddle 7000 according to the comparative example is different from the above-described paddle 70 according to this embodiment illustrated in FIG. 5 and FIG. 6 in that the first outer peripheral wall 75 includes a first arc wall 7100 instead of the first center wall 77 and the first inclined wall 78 and that the second outer peripheral wall 76 includes a second arc wall 7110 instead of the second center wall 80, the connection wall 83, and the second inclined wall 81.

In a case of the paddle 7000 according to the comparative example, for example, when the paddle 7000 reciprocates, the plating solution Ps easily escapes along a portion of the first arc wall 7100 and/or a portion of the second arc wall 7110 of the paddle 7000. In this respect, it cannot be said that the stirring force of the plating solution Ps by the paddle 7000 according to the comparative example is sufficiently large.

In contrast, with the paddle 70 according to this embodiment, since the first center wall 77 of the paddle 70 extends in the third direction (that is, the direction perpendicular to the reciprocation direction of the paddle 70), the first center wall 77 can effectively push out the plating solution Ps in the first direction when the paddle 70 moves in the first direction. This allows improving the stirring force of the plating solution Ps by the paddle 70.

Furthermore, according to this embodiment, since the second center wall 80 of the paddle 70 also extends in the third direction, the second center wall 80 can effectively push out the plating solution Ps in the second direction when the paddle 70 moves in the second direction. This allows further improving the stirring force of the plating solution Ps by the paddle 70.

According to this embodiment, as described above, since the stirring force of the plating solution Ps can be improved, the stirring force of a plating solution Pd especially in an outer peripheral portion of the substrate Wf can be improved. Consequently, the difference in stirring force of the plating solution Ps between a center portion of the substrate Wf and the outer peripheral portion of the substrate Wf can be decreased. Accordingly, when the plating process is performed on the substrate Wf at a high current density, the occurrence of abnormal plating in the outer peripheral portion of the substrate Wf can be suppressed.

According to this embodiment, as described above, since the stirring force of the plating solution Ps can be improved, homogenization of the plating solution Ps can be effectively attempted. Additionally, according to this embodiment, for example, even in a case where gas bubbles Bu (this is illustrated in FIG. 4) included in the plating solution Ps when the plating solution Ps is supplied to the plating tank 10 are accumulated in the holes 12a of the ionically resistive element 12, by stirring the plating solution Ps by the paddle 70, moving upward of the gas bubbles Bu accumulated in the holes 12a can be effectively prompted. Accordingly, the gas bubbles Bu accumulated in the holes 12a can be effectively removed.

Note that, in the above-described embodiment, while the second outer peripheral wall 76 includes the second center wall 80, the configuration is not limited thereto. In the above-described embodiment, the second outer peripheral wall 76 may have, for example, an arc shape like the second arc wall 7110 of the comparative example illustrated in FIG. 8 without the second center wall 80. However, the second outer peripheral wall 76 with the second center wall 80 is preferable compared with the second outer peripheral wall 76 having the arc shape in that the plating solution Ps can be effectively stirred.

### (Modification 1)

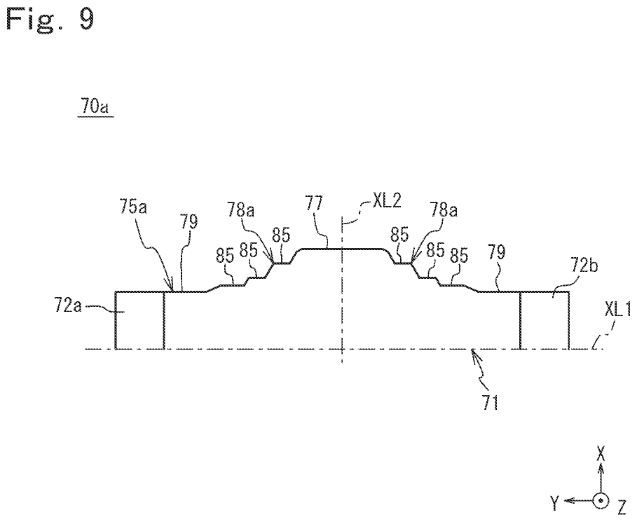

FIG. 9 is a schematic plan view illustrating a peripheral configuration of a first outer peripheral wall 75a described later of a paddle 70a according to Modification 1 of the embodiment. FIG. 9 illustrates only a portion in a first direction side with respect to the first central axis line XL1 of the paddle 70a according to this modification. In FIG. 9, the through-holes 74 of the honeycomb-structure portion 71 are not illustrated.

The paddle 70a according to this modification is different from the paddle 70 according to the embodiment illustrated in FIG. 6 in that the first outer peripheral wall 75a is provided instead of the first outer peripheral wall 75. The first outer peripheral wall 75a is different from the first outer peripheral wall 75 in that a first inclined wall 78a is provided instead of the first inclined wall 78. The other configurations of the paddle 70a are similar to the paddle 70 (in this case, the second outer peripheral wall 76 of the paddle 70a has the configuration illustrated in FIG. 6).

A pair of the first inclined walls 78a according to this modification are different from the pair of first inclined walls 78 (FIG. 6) according to the embodiment having a smooth surface without a step 85 in that at least one of the pair of first inclined walls 78a is provided with at least one step 85. That is, only any one of the two first inclined walls 78a according to this modification may be provided with the at least one step 85, or both of the two first inclined walls 78a may be provided with the at least one step 85. In the paddle 70a illustrated in FIG. 9, for example, both of the pair of first inclined walls 78a are provided with a plurality of the steps 85. The step 85 preferably has a planar surface extending in the third direction similarly to the first center wall 77.

According to this modification, since the first center wall 77 is provided and the first inclined wall 78a is provided with the step 85, both of the first center wall 77 and the step 85 of the first inclined wall 78a can effectively push out the plating solution Ps in the first direction when the paddle 70a moves in the first direction. This allows improving the stirring force of the plating solution Ps more.

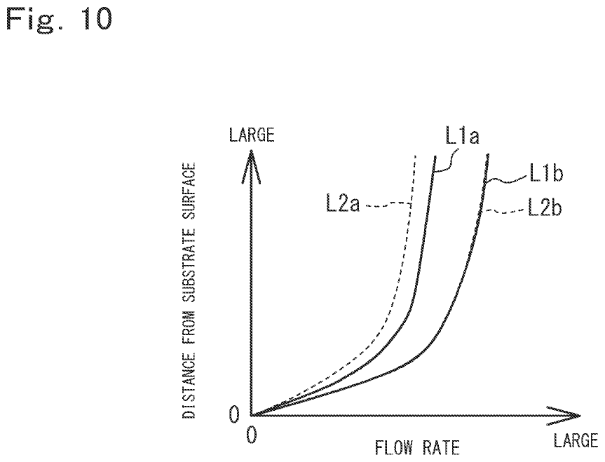

FIG. 10 is an example of a simulation result for proving an effect of the paddle 70a according to this modification. Specifically, a line L1a and a line L1b of FIG. 10 are simulation results of the paddle 70a according to this modification described in FIG. 9. Meanwhile, a line L2a and a line L2b are simulation results of the paddle 7000 (FIG. 8) according to the comparative example. In this modification according to the lines L1a, L1b, and in the comparative example according to the lines L2a, L2b, the simulation was performed under the same simulation condition other than the paddle shape. The line L1b and the line L2b overlap with one another. The horizontal axis of FIG. 10 indicates a flow rate (mm/sec) of the plating solution Ps in a case where the plating solution Ps is stirred by the reciprocation of the paddle. The vertical axis of FIG. 10 indicates a distance (μm) from the surface of the substrate Wf in the perpendicular direction.

Specifically, the line L1a and the line L2a indicate calculation results of the flow rate at any position (that is, a position in the outer peripheral portion of the substrate Wf) of “P2,” “P4,” “P6,” and “P8” illustrated in FIG. 5 when the paddle reciprocates. Meanwhile, the line L1b and the line L2b illustrate calculation results of the flow rate at a position of “PO” (that is, a position at the center portion of the substrate Wf) illustrated in FIG. 5.

As seen from the comparison between the line L1a (this modification) and the line L2a (comparative example) of FIG. 10, the flow rate increases overall in this modification compared with the comparative example in comparison at the same distance from the substrate Wf. Specifically, the flow rate of the line L1a is up to about 1.25 times the flow rate of the line L2a. Also from this simulation result, it is seen that the use of the paddle 70a according to this modification allows attempting the improvement of the stirring force of the plating solution Ps. It is especially seen that the improvement of the stirring force of the plating solution Pd in the outer peripheral portion of the substrate Wf can be attempted. Consequently, in a case of this modification, the flow rate difference between the line L1a and the line L1b is decreased compared with a case of the comparative example. That is, according to this modification, the difference in stirring force of the plating solution Ps between the center portion (line L1b) of the substrate Wf and the outer peripheral portion (L1a) of the substrate Wf can be reduced.

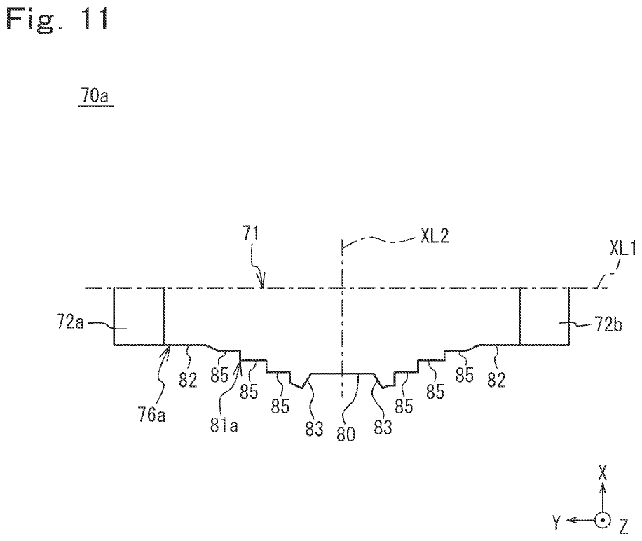

As illustrated in FIG. 11, in this modification, at least one of a pair of second inclined walls 81a of a second outer peripheral wall 76a may be provided with at least one step 85 similarly to the first inclined wall 78a. With this configuration, both of the second center wall 80 and the step 85 of the second inclined wall 81a can effectively push out the plating solution Ps in the second direction when the paddle 70a moves in the second direction. This allows improving the stirring force of the plating solution Ps more.

### (Modification 2)

FIG. 12 is a schematic plan view illustrating a peripheral configuration of a second outer peripheral wall 76b described later of a paddle 70b according to Modification 2 of the embodiment. FIG. 12 illustrates only a portion in a second direction side with respect to the first central axis line XL1 of the paddle 70b according to this modification. In FIG. 12, the through-holes 74 of the honeycomb-structure portion 71 are not illustrated.

The paddle 70b according to this modification is different from the paddle 70 according to the embodiment illustrated in FIG. 6 in that the second outer peripheral wall 76b is provided instead of the second outer peripheral wall 76. The second outer peripheral wall 76b is different from the second outer peripheral wall 76 in that the connection wall 83 is not provided. That is, the second inclined wall 81 of the second outer peripheral wall 76b according to this modification is directly connected to the end portion of the second center wall 80. The other configurations of the paddle 70b are similar to the paddle 70 (in this case, the first outer peripheral wall 75 of the paddle 70b has the configuration illustrated in FIG. 6).

This modification can provide the operational advantage similar to the above-described embodiment as well.

The paddle 70 can also have a configuration including the first outer peripheral wall 75a illustrated in FIG. 9 and the second outer peripheral wall 76b illustrated in FIG. 12.

### (Modification 3)

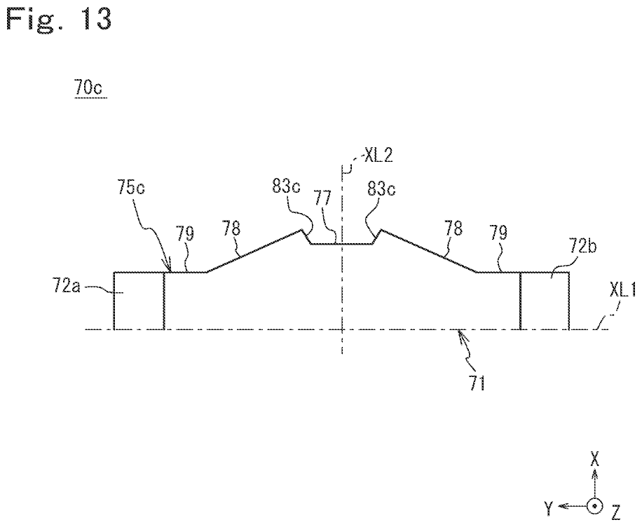

FIG. 13 is a schematic plan view illustrating a peripheral configuration of a first outer peripheral wall 75c described later of a paddle 70c according to Modification 3 of the embodiment. FIG. 13 illustrates only a portion in a first direction side with respect to the first central axis line XL1 of the paddle 70c according to this modification. In FIG. 13, the through-holes 74 of the honeycomb-structure portion 71 are not illustrated.

The paddle 70c according to this modification is different from the paddle 70 according to the embodiment illustrated in FIG. 6 in that the first outer peripheral wall 75c is provided instead of the first outer peripheral wall 75. The first outer peripheral wall 75c is different from the first outer peripheral wall 75 of the paddle 70 illustrated in FIG. 6 in that a pair of connection walls 83c connecting the first center wall 77 and the pair of first inclined walls 78 are further provided. The other configurations of the paddle 70c are similar to the paddle 70 (in this case, the second outer peripheral wall 76 of the paddle 70c has the configuration illustrated in FIG. 6).

The pair of connection walls 83c connect both end portions of the first center wall 77 to the pair of first inclined walls 78 respectively. The pair of connection walls 83c according to this modification extend from respective both end portions of the first center wall 77 as starting points in the first direction. Furthermore, the pair of connection walls 83c according to this modification extend to approach the end portions of the honeycomb-structure portion 71 as they extend toward the first direction. In other words, the pair of connection walls 83c according to this modification extend to get away from the second central axis line XL2 as they get away from the first central axis line XL1.

However, the configuration of the connection wall 83c is not limited thereto. For example, the connection wall 83c may extend in the reciprocation direction of the paddle 70c (in other words, may extend parallel to the second central axis line XL2).

This modification can provide the operational advantage similar to the above-described embodiment as well.

As described above, while details of the embodiments and modifications of the present invention have been described, the present invention is not limited to the specific embodiments and modifications, and various kinds of modifications and changes can further be made within the gist of the present invention.

### REFERENCE SIGNS LIST

10 . . . plating tank
11 . . . anode
30 . . . substrate holder
70 . . . paddle
71 . . . honeycomb-structure portion
74 . . . through-hole
75 . . . first outer peripheral wall
76 . . . second outer peripheral wall
77 . . . first center wall
78 . . . first inclined wall
79 . . . first end wall
80 . . . second center wall
81 . . . second inclined wall
82 . . . second end wall
83 . . . connection wall
85 . . . step
1000 . . . plating apparatus
Wf . . . substrate
Ps . . . plating solution
Bu . . . gas bubble
D2 . . . paddle width

1. A plating apparatus comprising:
a plating tank configured to store a plating solution, an anode being disposed in the plating tank;
a substrate holder configured to hold a substrate as a cathode so as to be opposed to the anode; and
a paddle disposed between the anode and the substrate, the paddle being configured to reciprocate parallel to the anode in a first direction and a second direction opposite to the first direction to stir the plating solution, the paddle including a honeycomb-structure portion provided with a plurality of polygonal through-holes, wherein
the honeycomb-structure portion has a shape in which a paddle width at a center portion in a third direction is wider than a paddle width at an end portion in the third direction, and the third direction is a direction perpendicular to a reciprocation direction of the paddle,
the honeycomb-structure portion includes a first outer peripheral wall oriented in the first direction, and
the first outer peripheral wall includes a first center wall disposed at a center portion in the third direction of the first outer peripheral wall, and the first center wall extends in the third direction.

2. The plating apparatus according to claim 1, wherein
the honeycomb-structure portion includes a second outer peripheral wall oriented in the second direction, and
the second outer peripheral wall includes a second center wall disposed at a center portion in the third direction of the second outer peripheral wall, and the second center wall extends in the third direction.

3. The plating apparatus according to claim 1, wherein
the first outer peripheral wall includes a pair of first inclined walls extending from both end portions of the first center wall as starting points in the second direction and directions approaching end portions of the honeycomb-structure portion.

4. The plating apparatus according to claim 3, wherein
at least one of the pair of first inclined walls is provided with at least one step.

5. The plating apparatus according to claim 2, wherein
the second outer peripheral wall includes a pair of second inclined walls extending from a center portion side in the third direction of the second outer peripheral wall toward the first direction while approaching end portion sides.

6. The plating apparatus according to claim 5, wherein
the second outer peripheral wall includes a pair of connection walls configured to connect both end portions of the second center wall to the pair of second inclined walls respectively.

7. A plating method using the plating apparatus according to claim 1, comprising:
immersing the substrate in the plating solution;
reciprocating the paddle in the first direction and the second direction to stir the plating solution; and
performing a plating process on the substrate.
